(19) United States
(12) Patent Application Publication
(10) Pub. No.: US 2021/0407743 A1
(43) Pub. Date: Dec. 30, 2021

(54) ALL-TEMPERATURE FLEXIBLE SUPERCAPACITORS INCLUDING HYDROGEL ELECTROLYTE

(71) Applicant: The Trustees of Columbia University in the City of New York, New York, NY (US)

(72) Inventors: Xi CHEN, New York, NY (US); Chao LU, New York, NY (US)

(73) Assignee: The Trustees of Columbia University in the City of New York, New York, NY (US)

(21) Appl. No.: 17/361,509

(22) Filed: Jun. 29, 2021

Related U.S. Application Data
(60) Provisional application No. 63/046,431, filed on Jun. 30, 2020.

(51) Int. Cl. H01G 11/62; H01G 11/60; H01G 11/32

(52) U.S. Cl. CPC H01G 11/62; H01G 11/32; H01G 11/60

(57) ABSTRACT

All-temperature flexible supercapacitors are prepared using a hydrogel electrolyte including a poly(vinyl alcohol) (PVA) substrate a montmorillonite (MMT) dopant, along with a 2M sulfuric acid and dimethyl sulfoxide/water aqueous electrolyte dispersed therein. Incorporation of MMT material enhances the thermal stability of PVA polymers, whereas the DMSO/H₂O binary system endows the hydrogel with an ultralow freezing point below −50° C. The hydrogel electrolyte displays good mechanical properties and shows superior electrochemical properties in a wide temperature range. The ionic conductivities are 0.17×10⁻⁴ and 0.76×10⁻⁴ S cm⁻¹ under operation temperatures of −50 and 90° C., respectively. The supercapacitor exhibits a high specific capacity of 161 F g⁻¹ with a high rate capability and life over 10,000 cycles. The flexible supercapacitors deliver a stable energy supply under various flexible conditions, including bending, twisting, and stretching states, and its capacity does not degrade obviously even after 1,000 bending cycles.

### CROSS REFERENCE TO RELATED APPLICATION(S)

This application claims the benefit of U.S. Provisional Application No. 63/046,431, filed Jun. 30, 2020, which is incorporated by reference as if disclosed herein in its entirety.

### BACKGROUND

Flexible supercapacitors with merits such as low weight, high power density, and flexibility have attracted tremendous attention from researchers in material and energy fields and have shown great potential for powering wearable electronics. In some instances, flexible energy storage devices need to be able to work in harsh environments, especially in severe cold and hot regions. However, until now, there is little reported on the successful fabrication of all-temperature flexible supercapacitors, which is mainly limited by insufficient performances of hydrogel electrolytes under a wide temperature range. Conventional hydrogel electrolytes include large amounts of water molecules, which are easy to freeze under subzero temperatures and lead to insufficient ionic conductivity of electrolytes. In addition, structures of conventional hydrogel electrolytes are unstable, and the water molecules inside are unable to remain under high temperatures. These issues associated with hydrogel electrolytes severely deteriorate the electrochemical performances and practical applications of devices in harsh environments, and remain as obstacles for realizing fabrication of all-temperature flexible supercapacitors. Thus, developing anti-freezing and thermally stable hydrogel electrolytes through a feasible material engineering strategy is becoming a critical challenge for addressing these issues in this field.

Material structure engineering of hydrogel electrolytes, including incorporation of a thermally stable component and modification of anti-freezing aqueous electrolytes, is a promising strategy to prepare all-temperature hydrogel electrolytes. Montmorillonite (MMT) materials are reported to be excellent dopants with the capability of enhancing the thermal properties of polymers.

Further, the strong hydrogen-bond interaction between water molecules in aqueous electrolytes is an obstacle to preparing anti-freezing aqueous electrolytes. Dimethyl sulfoxide (DMSO) is a sulfur-including compound with strong polarity, a high boiling point, and good chemical stability. DMSO is a common organic solvent with good solubility with most inorganic and organic compounds, especially when dissolved with water in any ratio. In DMSO/H₂O solution, the strong hydrogen-bond interactions between water and DMSO molecules significantly weaken the hydrogen-bond interactions within the water molecules, and the freezing point of the binary solution system decreases significantly.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic drawing of a flexible supercapacitor electrolyte according to some embodiments of the present disclosure;

FIGS. 2A and 2B are scanning electron microscopy (SEM) images of montmorillonite (MMT) material as used in supercapacitors according to some embodiments of the present disclosure;

FIGS. 2C-2D are transmission electron microscopy images of MMT material as used in supercapacitors according to some embodiments of the present disclosure;

FIG. 2E is a cross-sectional SEM image of MMT material as used in supercapacitors according to some embodiments of the present disclosure;

FIGS. 2F-2I are energy dispersive X-ray spectrometry elemental mappings of MMT material as used in supercapacitors according to some embodiments of the present disclosure;

FIG. 3A is a surface SEM image of a flexible supercapacitor electrolyte including poly(vinyl alcohol) (PVA) and MMT material according to some embodiments of the present disclosure;

FIG. 3B is a cross-sectional SEM image of a flexible supercapacitor electrolyte including PVA and MMT material according to some embodiments of the present disclosure;

FIGS. 3C-3F are images of a flexible supercapacitor electrolyte including PVA and MMT material according to some embodiments of the present disclosure;

FIG. 3G is a graph of x-ray diffraction patterns for PVA, MNIT, and MMT/PVA samples;

FIG. 3H is a graph showing stress-strain curves of a PVA/MMT material flexible supercapacitor electrolyte according to some embodiments of the present disclosure;

FIG. 3I is a graph showing a thermogravimetric analysis of a PVA/MMT material flexible supercapacitor electrolyte according to some embodiments of the present disclosure;

FIG. 4 is a schematic drawing of a flexible supercapacitor according to some embodiments of the present disclosure;

FIG. 5A is an SEM image of graphene as used in supercapacitors according to some embodiments of the present disclosure;

FIG. 5B is a TEM image of graphene as used in supercapacitors according to some embodiments of the present disclosure;

FIG. 6A is an electrochemical impedance spectroscopy plot of a flexible supercapacitor according to some embodiments of the present disclosure;

FIG. 6B is a graph showing cyclic voltammogram (CV) curves for a flexible supercapacitor according to some embodiments of the present disclosure;

FIG. 6C is a graph showing galvanostatic charge-discharge (GCD) curves for a flexible supercapacitor according to some embodiments of the present disclosure;

FIG. 6D is a graph showing the energy storage capacity of a flexible supercapacitor according to some embodiments of the present disclosure;

FIG. 6E is a graph showing performance degradation of a flexible supercapacitor according to some embodiments of the present disclosure;

FIGS. 7A-7C are graphs showing GCD curves for a flexible supercapacitor according to some embodiments of the present disclosure under bending, twisting, and stretching states;

FIG. 7D is a graph showing the ionic conductivity of a flexible supercapacitor according to some embodiments of the present disclosure at various temperatures;

FIG. 7E is a graph showing cyclic voltammogram (CV) curves for a flexible supercapacitor according to some embodiments of the present disclosure at various temperatures;

FIG. 7F is a graph showing GCD curves for a flexible supercapacitor according to some embodiments of the present disclosure at various temperatures;

FIG. 8 is a dynamic mechanical analysis (DMA) of a flexible supercapacitor according to some embodiments of the present disclosure;

FIG. 9A is a graph showing differential scanning calorimetry (DSC) analysis of dimethyl sulfoxide/H₂O as used in supercapacitors according to some embodiments of the present disclosure;

FIG. 9B is a graph showing specific capacitances of supercapacitors according to some embodiments of the present disclosure; and

FIG. 10 is a chart of a method of making a flexible supercapacitor according to some embodiments of the present disclosure.

### SUMMARY

Aspects of the present disclosure are directed to a flexible supercapacitor electrolyte including a polymeric hydrogel matrix, a concentration of montmorillonite material, and an aqueous liquid electrolyte component incorporated into the polymeric hydrogel matrix. In some embodiments, the montmorillonite material is substantially evenly dispersed in the polymeric hydrogel matrix. In some embodiments, the polymeric hydrogel matrix includes poly(vinyl alcohol), polyacrylates, agarose, or combinations thereof. In some embodiments, the mass ratio of montmorillonite material to polymeric hydrogel matrix (MMT:PHM) is between about 1:5 and about 1:15. In some embodiments, the MMT:PHM is about 1:9. In some embodiments, the aqueous liquid electrolyte has a melting temperature below about 0° C. In some embodiments, the aqueous liquid electrolyte component includes sulfuric acid and dimethyl sulfoxide/water at a 1:1 molar ratio. In some embodiments, the aqueous liquid electrolyte component has a concentration of about 2M.

Aspects of the present disclosure are directed to a flexible supercapacitor including one or more pairs of electrode layers and a flexible supercapacitor electrolyte layer disposed between each pair of electrode layers. In some embodiments, the flexible supercapacitor electrolyte layer includes a polymeric hydrogel matrix, a concentration of montmorillonite material, and an aqueous liquid electrolyte component incorporated into the polymeric hydrogel matrix. In some embodiments, the montmorillonite material is substantially evenly dispersed in the polymeric hydrogel matrix. In some embodiments, the polymeric hydrogel matrix includes poly(vinyl alcohol), polyacrylates, agarose, or combinations thereof. In some embodiments, the mass ratio of montmorillonite material to polymeric hydrogel matrix (MMT:PHM) is about 1:9. In some embodiments, the aqueous liquid electrolyte component includes dimethyl sulfoxide (DMSO). In some embodiments, the aqueous liquid electrolyte component includes sulfuric acid and DMSO/water at a 1:1 molar ratio. In some embodiments, the aqueous liquid electrolyte component has a concentration of about 2M. In some embodiments, the electrode layers include graphene.

Aspects of the present disclosure are directed to a method of making a flexible supercapacitor including mixing an aqueous suspension including one or more polymers and a concentration of montmorillonite material, heating the aqueous suspension to form a construct, drying the construct under vacuum, immersing the dried construct in an aqueous liquid electrolyte to form a hydrogel electrolyte layer, and laminating the hydrogel electrolyte layer with at least two electrode layers. In some embodiments, the one or more polymers includes poly(vinyl alcohol) and the mass ratio of montmorillonite material to poly(vinyl alcohol) (MMT:PVA) is between about 1:9. In some embodiments, the aqueous liquid electrolyte is 2M sulfuric acid and dimethyl sulfoxide/water at a 1:1 molar ratio. In some embodiments, the electrode layers include graphene.

### DESCRIPTION

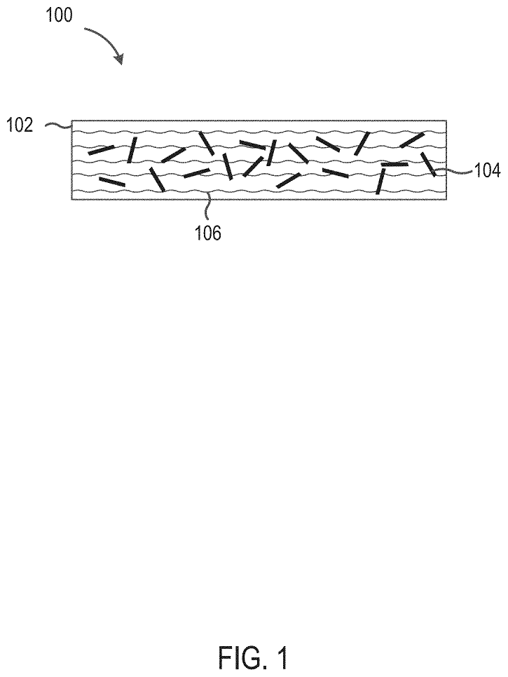

Referring now to FIG. 1, some embodiments of the present disclosure are directed to a flexible supercapacitor electrolyte 100. In some embodiments, flexible supercapacitor electrolyte 100 is a hydrogel. In some embodiments, flexible supercapacitor electrolyte 100 has a tensile modulus above about 10 MPa. In some embodiments, flexible supercapacitor electrolyte 100 has a break elongation above about 14%. In some embodiments, flexible supercapacitor electrolyte 100 includes a substrate 102 and a dopant 104. In some embodiments, substrate 102 is a polymeric hydrogel matrix. In some embodiments, the polymeric hydrogel matrix is formed from natural polymers, synthetic polymers, or combinations thereof. In some embodiments, the polymeric hydrogel matrix is hydrophilic. In some embodiments, the polymeric hydrogel matrix includes one or more polymers having a melting point above about 90° C. In some embodiments, the polymeric hydrogel matrix includes polyvinyl polymers, e.g., poly(vinyl alcohol), polyacrylates, e.g., polyacrylic acid, agarose, or combinations thereof. The polymeric hydrogel matrix of flexible supercapacitor electrolyte 100 is lightweight and highly flexible. The polymeric hydrogel matrix also maintains a high adsorption capacity for aqueous electrolyte and thus is highly advantageous for use in flexible semiconductors, as moderate twists and stretches will not damage the flexible supercapacitor, allowing for bends, twists and stretches as the flexible supercapacitor is cycled, even through 1,000 charges.

In some embodiments, dopant 104 is a concentration of montmorillonite material. In some embodiment, the montmorillonite material is substantially evenly dispersed in the polymeric hydrogel matrix. In some embodiments, the mass ratio of montmorillonite material to polymeric hydrogel matrix (MMT:PHM) in flexible supercapacitor electrolyte 100 is between about 1:5 and about 1:15. In some embodiments, the MMT:PHM is about 1:9. Without wishing to be bound by theory, the montmorillonite material promotes ionic conductivity due to its lamellar nanostructure. The montmorillonite materials lamellar structures facilitate ion conduction due to formation of oriented conductive pathways and enhance the thermal stability of flexible supercapacitor electrolyte 100, making the electrolyte advantageous for use in supercapacitor applications.

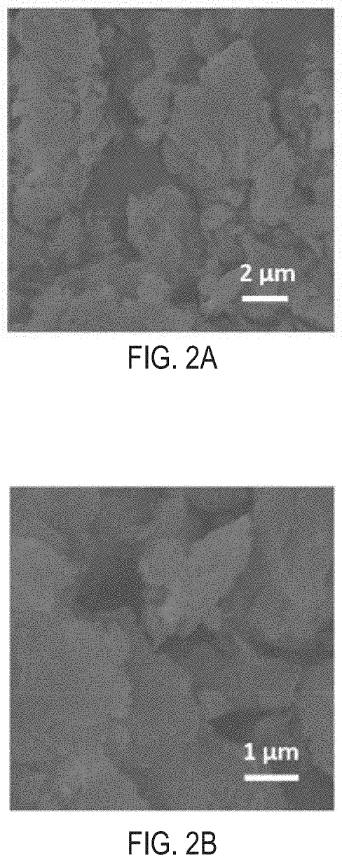

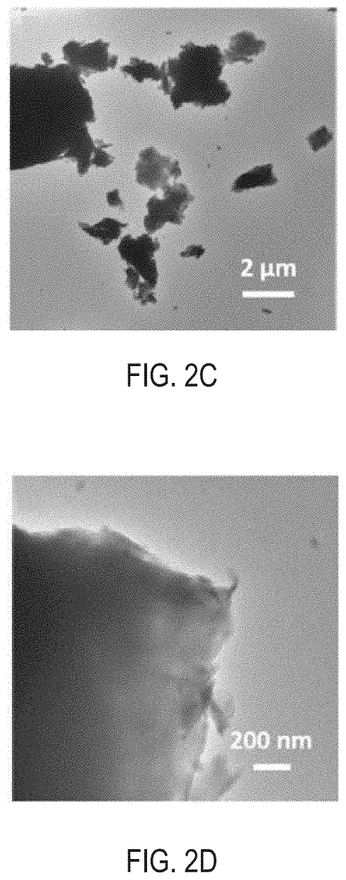

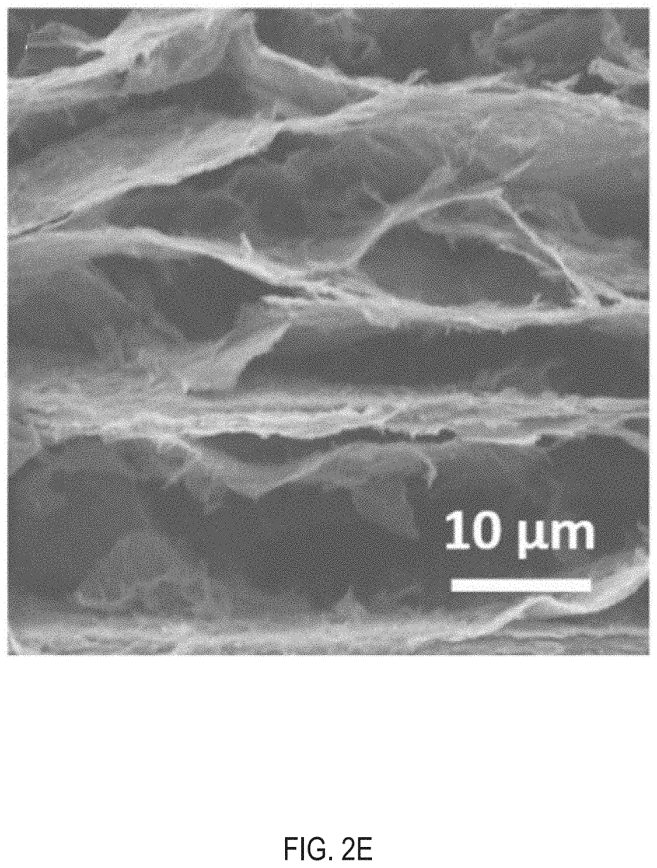

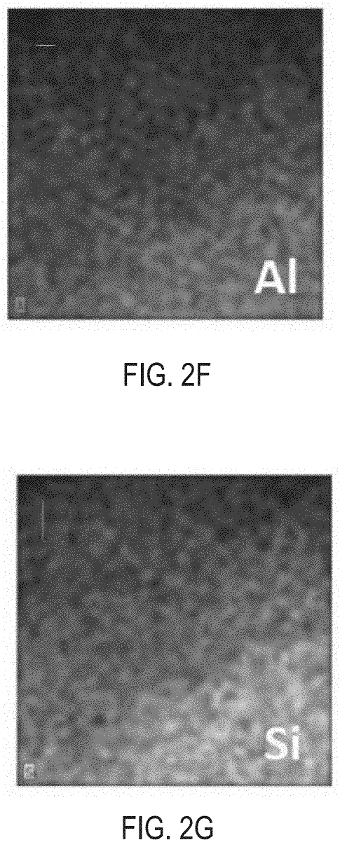

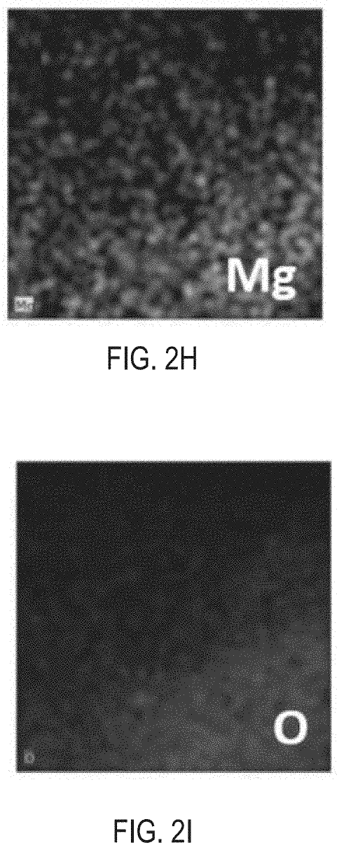

Referring now to FIGS. 2A-2I, the micro morphology of montmorillonite (MMT) material was investigated by scanning electron microscopy (SEM) and transmission electron microscopy (TEM) techniques. SEM images of MMT material in FIGS. 2A-2B indicate the porous structure, which is favorable for promoting ion storage and migration. TEM images in FIGS. 2C-2D verify the lamellar structure of the MMT material, and the lamellar structure can help to form oriented ion conductive pathways in the polymeric hydrogel matrix, which promotes ionic kinetics under electrochemical processes.

Referring specifically to FIG. 2E, to further demonstrate the lamellar structure of MMT, MMT material was deposited onto a substrate with a vacuum filtration method and then characterized via cross-sectional SEM. The lamellar structure of MMT material is clearly shown in the SEM image. This effect is reflected in the energy storage capacity and rate capability of the hydrogel-based supercapacitors. Energy dispersive X-ray (EDX) spectrometry elemental mappings were employed to examine typical chemical components in MMT material. From the EDX elemental mappings in FIGS. 2F-2I, it can be concluded that aluminum (Al), silicon (Si), magnesium (Mg), and oxygen (O) are uniformly distributed in MMT material.

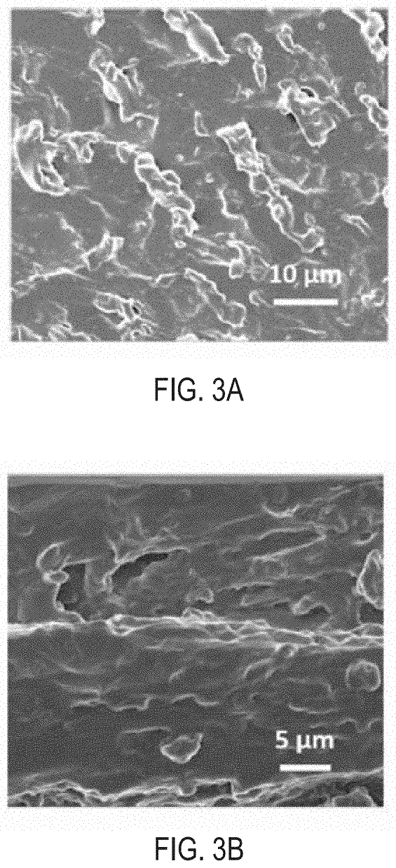

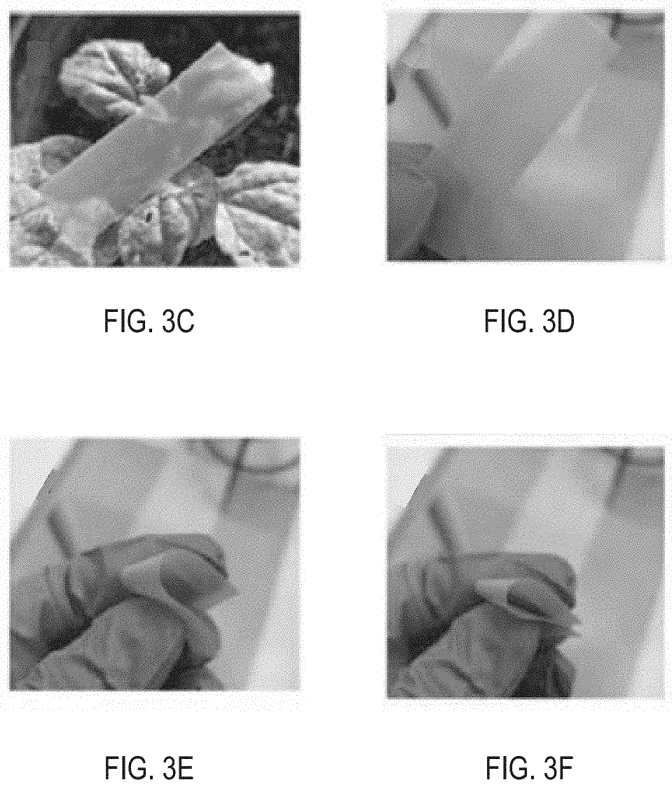

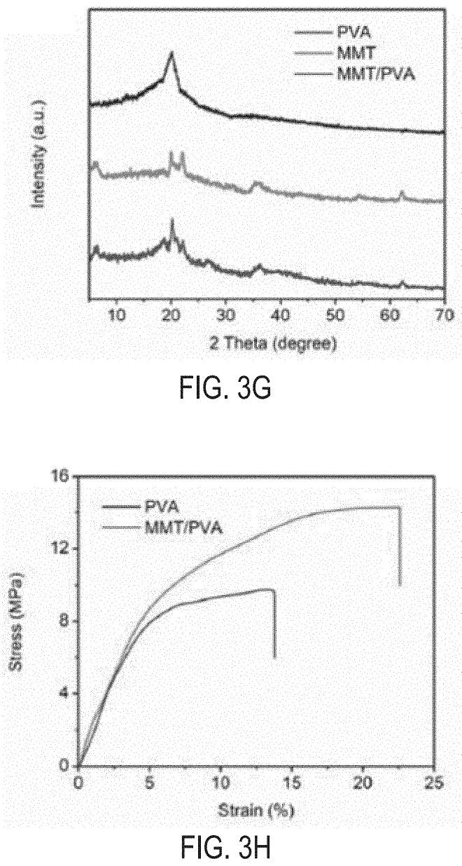

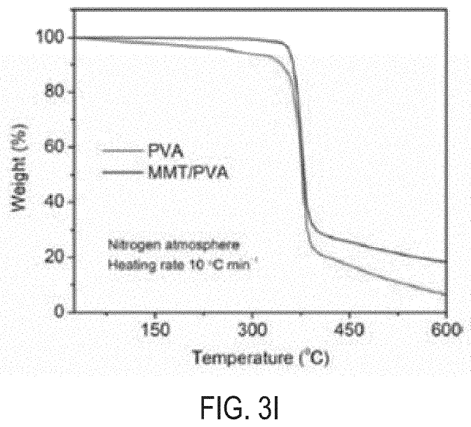

Referring now to FIGS. 3A-3I, morphology and structural analysis of an exemplary embodiment of flexible supercapacitor electrolyte 100 including a poly(vinyl alcohol) (PVA) hydrogel substrate 102 and an MMT dopant 104 were conducted in order to further characterize the role of MMT in the hydrogel. Surface and cross-sectional SEM images of the construct in FIG. 3A-3B indicate that MMT material is uniformly distributed in the PVA polymer substrate with good homogeneity. The yellow-colored MMT/PVA construct is clearly shown in FIG. 3C-3F. The construct is so lightweight that it can be lifted up even by tender leaves, and it can be easily bent. A comparison of XRD patterns of PVA, MMT, and MMT/PVA samples are illustrated in FIG. 3G, and it can be concluded from the typical characteristic peaks that MMT material has been successfully incorporated into the PVA substrate.

Referring now to FIG. 3H, stress-strain curves of a sample of MMT/PVA and a sample of PVA were obtained to examine their mechanical property differences. The tensile modulus of MMT/PVA was 14.3 MPa with a break elongation of 22.6%, whereas those of the PVA construct were 9.58 MPa and 13.8%, respectively. Without wishing to be bound by theory, the improved mechanical properties of the MMT/PVA sample are mainly attributed to the plasticization effect of MMT flakes in PVA sample, as well as homogeneity of the composite.

Referring now to FIG. 3I, thermogravimetric analysis was performed on the MMT/PVA sample to characterize its thermal stability. It was found that the MMT/PVA construct exhibits a thermal stability higher than that of a PVA sample within a temperature range from 50° C. to 300° C., which, without wishing to be bound by theory, should be ascribed to strong hydrogen-bond interactions between oxygen-including groups on MMT and hydroxyl groups on PVA polymers.

Referring again to FIG. 1, in some embodiments, an aqueous liquid electrolyte component 106 is incorporated into substrate 102. In some embodiments, aqueous liquid electrolyte component 106 has a melting temperature below about 0° C. In some embodiments, aqueous liquid electrolyte component 106 has a melting temperature below about −10° C. In some embodiments, aqueous liquid electrolyte component 106 has a melting temperature below about −20° C. In some embodiments, aqueous liquid electrolyte component 106 has a melting temperature below about −30° C. In some embodiments, aqueous liquid electrolyte component 106 has a melting temperature below about −40° C. In some embodiments, aqueous liquid electrolyte component 106 has a melting temperature between about −60° C. and about −40° C. In some embodiments, aqueous liquid electrolyte component 106 has a melting temperature of about −50° C. In some embodiments, aqueous liquid electrolyte component 106 includes dimethyl sulfoxide (DMSO). In some embodiments, aqueous liquid electrolyte component 106 includes DMSO and water. In some embodiments, aqueous liquid electrolyte component 106 includes sulfuric acid, DMSO, and water. In some embodiments, aqueous liquid electrolyte component 106 includes sulfuric acid and DMSO/water at a 1:1 molar ratio. In some embodiments, aqueous liquid electrolyte component 106 has a concentration between about 1M and 3M. In some embodiments, aqueous liquid electrolyte component 106 has a concentration of about 2M. The aqueous liquid electrolyte component 106 has a low freezing point and is able to remain incorporated in flexible supercapacitor electrolyte 100 in a liquid phase even at low operating temperatures. In an exemplary embodiment, a 2M H₂SO₄ DMSO/H₂O aqueous electrolyte has a freezing point below −50° C. and provides sufficient ionic conductivities for electrochemical dynamics of supercapacitors. Without wishing to be bound by theory, hydrogen bonds formed between DMSO and water molecules significantly weaken the solvent effect between ions and water molecules. This weakened solvated system promotes ionic migration kinetics during electrochemical charge-discharge processes. The ionic conductivity of 2M H₂SO₄ DMSO/H₂O aqueous electrolyte reaches as high as 0.17×10⁻⁴ S cm⁻¹ under the extremely low temperature of −50° C.

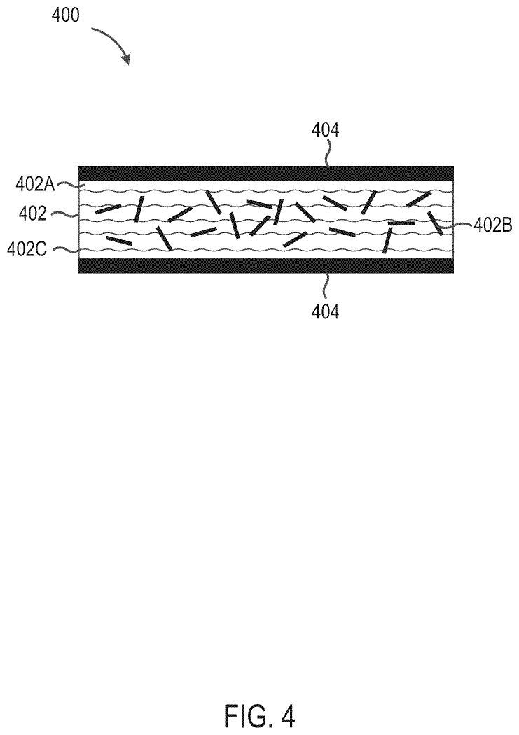

Referring now to FIG. 4, some embodiments of the present disclosure are directed to a flexible supercapacitor 400. In some embodiments, the supercapacitor has a generally lamellar structure. Flexible supercapacitor 400 includes one or more flexible supercapacitor electrolyte layers 402. Flexible supercapacitor electrolyte layers 402 are consistent with the embodiments of flexible supercapacitor electrolyte 100 discussed above. In some embodiments, at least one of the flexible supercapacitor electrolyte layers 402 include a polymeric hydrogel matrix 402A. In some embodiments, polymeric hydrogel matrix 402A is formed from natural polymers, synthetic polymers, or combinations thereof. In some embodiments, polymeric hydrogel matrix 402A is hydrophilic. In some embodiments, polymeric hydrogel matrix 402A includes one or more polymers having a melting point above about 90° C. In some embodiments, polymeric hydrogel matrix 402A includes polyvinyl polymers, e.g., poly(vinyl alcohol), polyacrylates, e.g., polyacrylic acid, agarose, or combinations thereof. In some embodiments, at least one of the flexible supercapacitor electrolyte layers 402 includes a concentration of montmorillonite material 402B. In some embodiment, montmorillonite material 402B is substantially evenly dispersed in flexible supercapacitor electrolyte layer 402. In some embodiments, the mass ratio of montmorillonite material to polymeric hydrogel matrix (MMT:PHM) is between about 1:5 and about 1:15. In some embodiments, the MMT:PHM is about 1:9. In some embodiments, flexible supercapacitor 400 includes one or more pairs of electrode layers 404. Flexible supercapacitor electrolyte layers 402 are disposed between each pair of electrode layers 404. In some embodiments, electrode layer 404 includes one or more carbon-based materials. In some embodiments, electrode layer 404 includes graphene. In some embodiments, flexible supercapacitor electrolyte layers 402 include an aqueous liquid electrolyte component 402C. In some embodiments, aqueous liquid electrolyte component 402C is incorporated into polymeric hydrogel matrix 402A. In some embodiments, aqueous liquid electrolyte component 402C has a melting temperature below about 0° C. In some embodiments, aqueous liquid electrolyte component 402C has a melting temperature below about −10° C. In some embodiments, aqueous liquid electrolyte component 402C has a melting temperature below about −20° C. In some embodiments, aqueous liquid electrolyte component 402C has a melting temperature below about −30° C. In some embodiments, aqueous liquid electrolyte component 402C has a melting temperature below about −40° C. In some embodiments, aqueous liquid electrolyte component 402C has a melting temperature between about −60° C. and about −40° C. In some embodiments, aqueous liquid electrolyte component 402C has a melting temperature of about −50° C. In some embodiments, aqueous liquid electrolyte component 402C includes dimethyl sulfoxide (DMSO). In some embodiments, aqueous liquid electrolyte component 402C includes DMSO and water. In some embodiments, aqueous liquid electrolyte component 402C includes sulfuric acid, DMSO, and water. In some embodiments, aqueous liquid electrolyte component 402C includes sulfuric acid and DMSO/water at a 1:1 molar ratio. In some embodiments, aqueous liquid electrolyte component 402C has a concentration between about 1M and 3M. In some embodiments, aqueous liquid electrolyte component 402C has a concentration of about 2M.

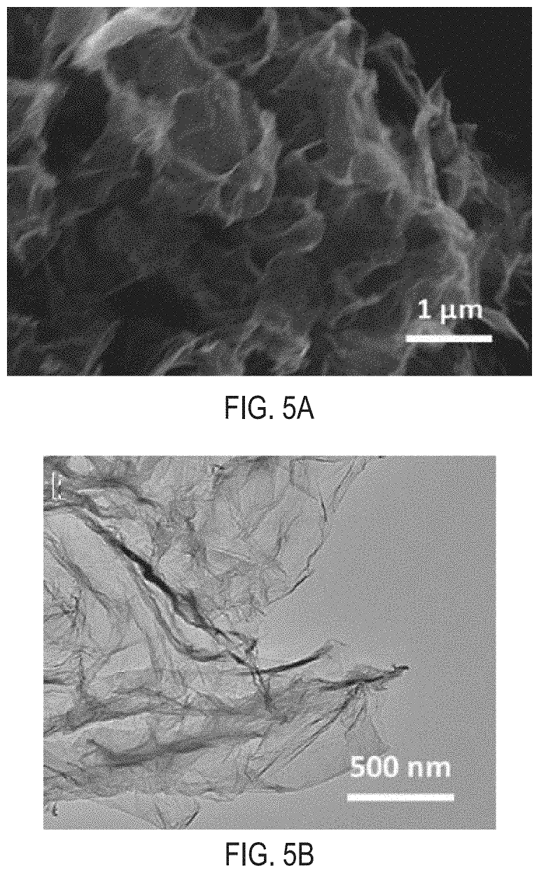

Referring now to FIG. 5A-5B, in an exemplary embodiment, an all-solid-state supercapacitor was fabricated by assembling a MMT/PVA hydrogel with graphene electrodes and 2M H₂SO₄ DMSO/H₂O electrolyte. The SEM (FIG. 5A) and TEM (FIG. 5B) images reflect the porous and two-dimensional structure of graphene materials, which favors accommodation and transfer of active ions during electrochemical processes.

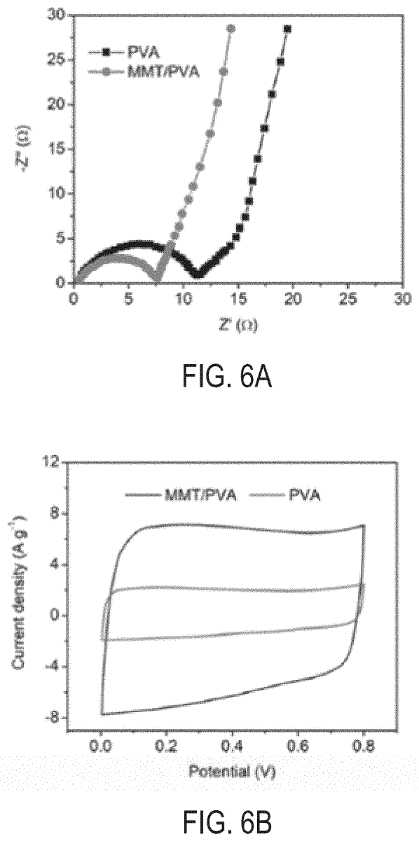

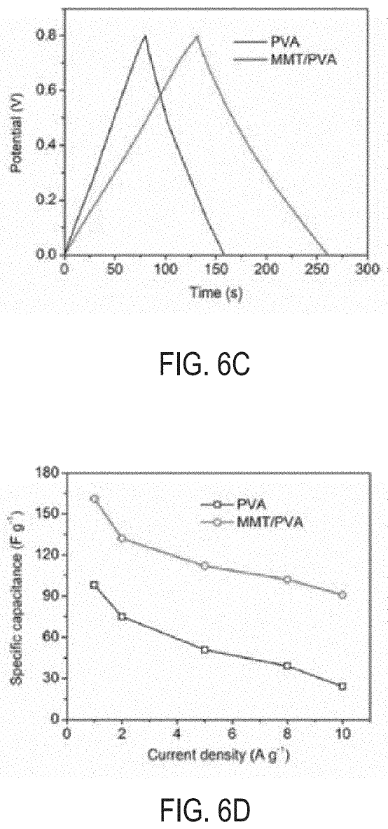

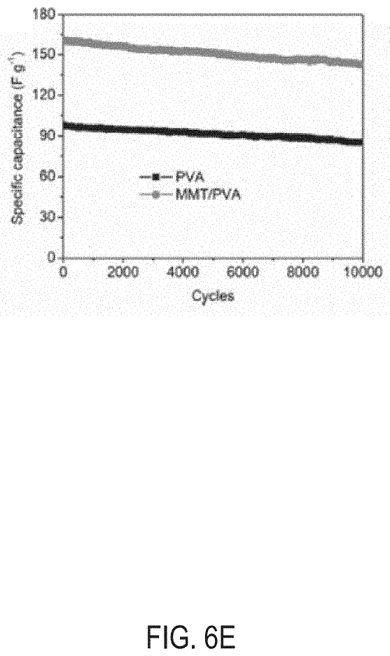

Referring now to FIG. 6A-6E, Nyquist plots for MMT/PVA and PVA hydrogel electrolyte-based supercapacitors indicated a lower interface resistance of the MMT/PVA hydrogel-based flexible supercapacitor compared with PVA alone owing to the higher ionic conductivity. The cyclic voltammogram (CV) curves in FIG. 6B show a regular rectangular shape, which indicates a typical capacitive energy storage mechanism. The rectangular shape is well-retained even under a high scan rate of 200 mV s⁻¹, verifying the robust rate capability of the supercapacitors. As mentioned above, without wishing to be bound by theory, compared with the disordered structure of PVA, the lamellar structure of MMT provides oriented channels in PVA for more efficient ion migration. Ion channels formed between lamellar structures of MA/IT materials are beneficial to surface-charge-governed ion transport for electrolytes under an electrochemical process. The Nyquist plots in FIG. 6A also indicate the lower interface resistance and higher ionic conductivity of the MMT/PVA hydrogel-based flexible supercapacitor. Thus, more active ions can be accessible to the interface and then migrate into electrodes in the MMT/PVA supercapacitor under the same electrochemical conditions and display a specific capacitance higher than that of PVA.

Referring now to FIG. 6C, galvanostatic charge-discharge (GCD) curves of the flexible supercapacitors are measured at a current density of 1 A g′ under a voltage of 0.8 V for comparison of their energy capacities. The nearly triangular shapes verify the high Coulombic efficiency. It is found that the MMT/PVA hydrogel-based flexible supercapacitor exhibits an energy storage capacity higher than that of the pure PVA-based one in FIG. 6D, and the specific capacitance of the MMT/PVA hydrogel-based flexible supercapacitor exhibits 161 F g⁻¹ at a current density of 1 A g⁻¹ and still remains at 91 F g⁻¹ at a high current density of 10 A g⁻¹, showing the good rate capability. After 10,000 working cycles, capacitance retention of the MMT/PVA-based flexible supercapacitor was 95% (from 161 to 153 F g⁻¹), whereas the capacitance retention of the PVA-based flexible supercapacitor was 93% (from 98 to 91 F g⁻¹). The performance degradation trend of the two devices was similar, as shown in FIG. 6E. These two devices display good cycling stability, and the capacitance retention of the MMT/PVA-based flexible supercapacitor is slightly higher than that of the PVA-based counterpart. The improved energy storage properties with long cycling life present great potential for practical applications.

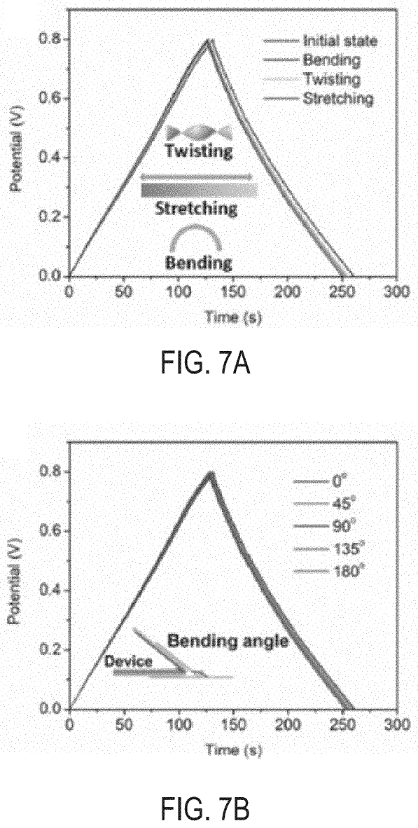

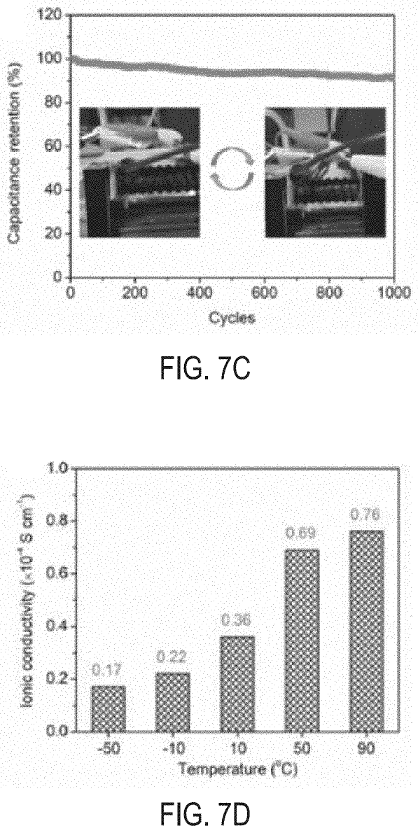

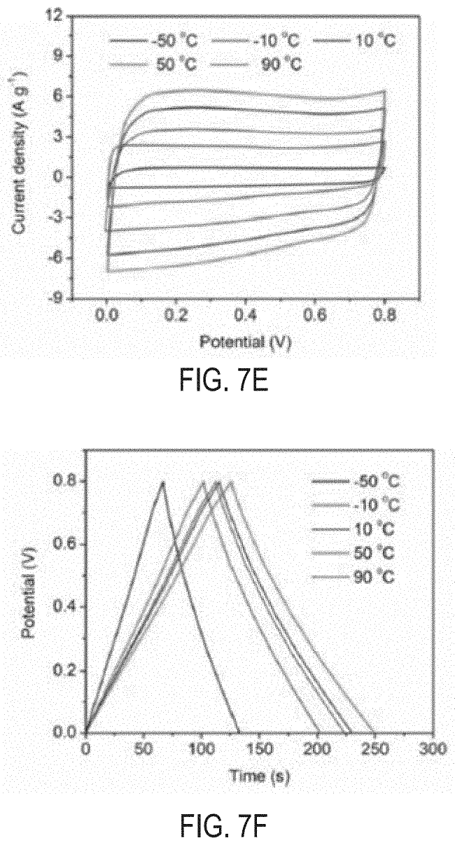

Flexibility of the MMT/PVA hydrogel-based supercapacitors determines whether they can be applied as power sources for wearable electronic devices. Referring now to FIGS. 7A-7C, GCD curves of the flexible supercapacitor under bending, twisting, and stretching states indicated negligible capacity degradation. In addition, capacitance of the flexible supercapacitor was tested under different bending angles from 0 to 180° at 1 A g⁻¹. The results verify that MMT/PVA hydrogel-based supercapacitors according to some embodiments of the present disclosure can keep giving a stable power supply under large bending deformations. Further, specific capacitance of the flexible supercapacitor remained at 91% after 1,000 bending cycles, showing the great flexibility.

Operation temperature range is a notable parameter for flexible supercapacitors because the flexible supercapacitors could be working under harsh environments in some special conditions. However, conventional hydrogel electrolytes cannot operate under wide temperature ranges, hindered by freezing at low temperatures and structure deterioration at high temperatures. The MMT and 2M H₂SO₄ DMSO/H₂O aqueous electrolyte components of the exemplary embodiment address these issues. Referring now to FIG. 7D-7E, ionic conductivity of MMT/PVA hydrogel-based supercapacitors was carried out within the range from −50 to 90° C. The ionic conductivity remained as high as 0.17×10⁻⁴ S cm⁻¹ at the ultralow temperature of −50° C., which is sufficient for operation of supercapacitors. The ionic conductivity was 0.76×10⁻⁴ S cm⁻¹ at the high temperature of 90° C. without structure deterioration. The CV curves of FIG. 7E show MMT/PVA hydrogel-based supercapacitors at different temperatures. Without wishing to be bound by theory, the decreased integral areas of curves resulted from the reduced ion diffusion kinetics with variation of operation temperatures, but their rectangle shapes have not substantially changed, which demonstrates the superior stability of the supercapacitors. Referring now to FIG. 7F, under a temperature range from −50 to 30° C., specific capacitance of the capacitors increased with increasing operation temperature owing to the enhancement of ionic kinetics. At a temperature range from 30 to 90° C., the specific capacitance decreased with increasing temperature, which is caused by segmental relaxation of PVA polymers near the glass transition temperature and thus slightly decreases the energy capacity.

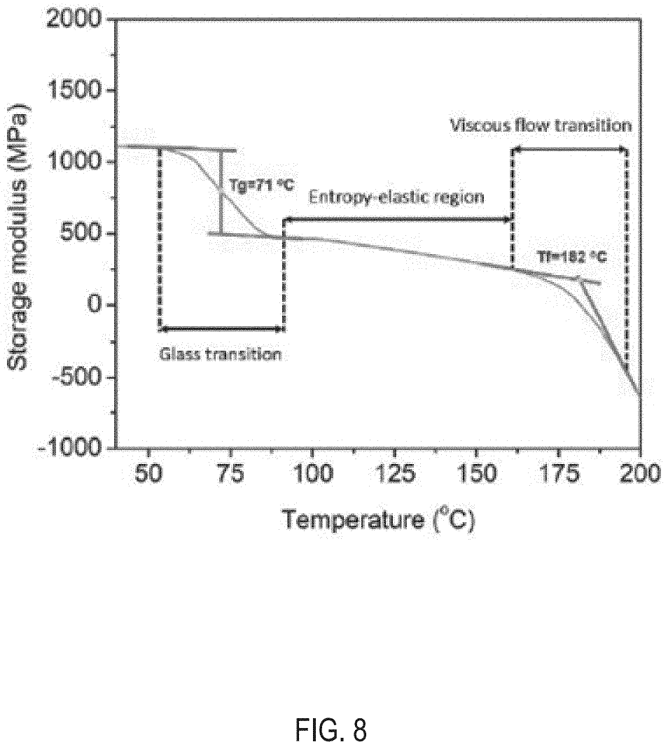

Referring now to FIG. 8, in order to provide the glass transition temperature (T_{g}) of MMT/PVA material, dynamic mechanical analysis (DMA) of the exemplary supercapacitor was conducted under frequencies from 0.1 to 20 Hz, temperatures from 40 to 200° C., and a heating rate of 5° C. min-1. From the DMA result, it can be found that the practical T_{g} value of MMT/PVA material was 71° C. Moreover, according to the analysis of viscous flow transition region on the DMA curve, viscous flow temperature (T_{f}) of the MMT/PVA material was 182° C. The temperature gap between T_{g} and T_{f} was as high as 111° C., and thus the polymer chains will not collapse or be in a viscous state under a high working temperature even above 90° C. Thus, supercapacitors based on the MMT/PVA polyelectrolyte can work stably under this temperature range.

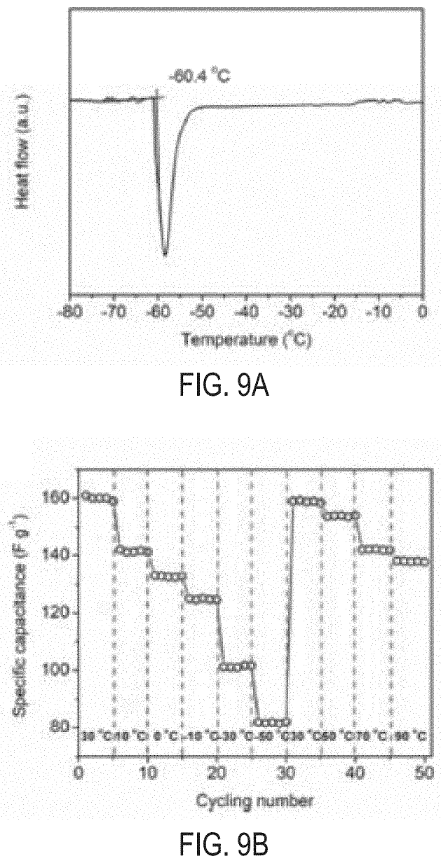

Referring now to FIGS. 9A-9B, the differential scanning calorimetry (DSC) result of DMSO/H₂O solvent indicated that the freezing point of DMSO/H₂O solvent reaches an ultralow value of −60.4° C., which is an advantageous electrolyte for low-temperature operation supercapacitors. The freezing points of pure water and DMSO solvents are 0 and 18.6° C., respectively. Mixtures of DMSO and water can achieve much lower freezing points because hydrogen bonds formed between DMSO and water molecules significantly reduce hydrogen bonds within water molecules. The MMT/PVA hydrogel electrolyte-based supercapacitor of the exemplary embodiment can keep illumining a LED light whether the flexible supercapacitor is heated to a high temperature or laminated by cold ice, and further can operate well throughout an all temperature range from −50 to 90° C. with good cycling stability (see FIG. 9B).

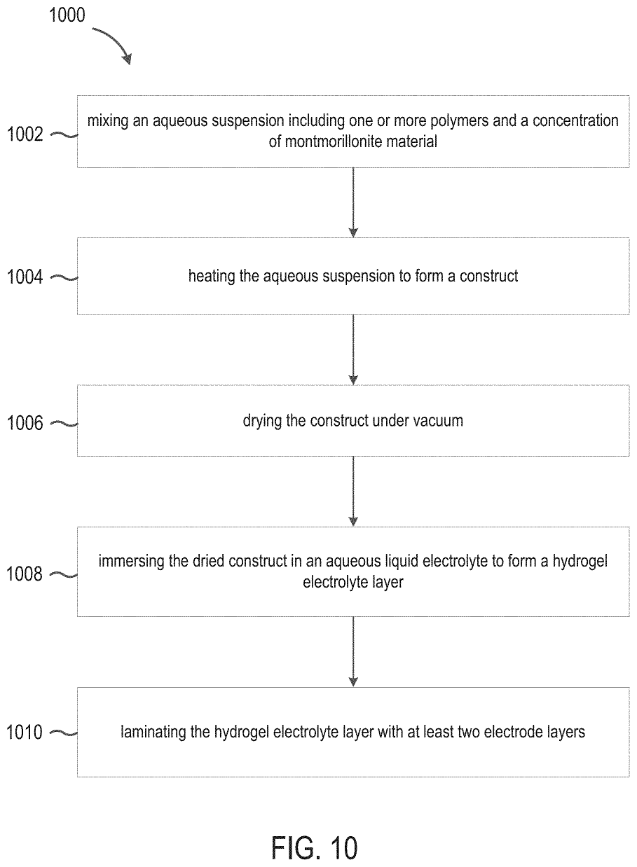

Referring now to FIG. 10, some embodiments of the present disclosure are directed to a method 1,000 of making a flexible supercapacitor. In some embodiments, the flexible supercapacitor is consistent with the embodiments of flexible supercapacitor 400 discussed above. At 1002, an aqueous suspension including one or more polymers and a concentration of montmorillonite material is mixed. In some embodiments, mixing 1002 occurs in water with assistance of sharking, stirring, ultrasonic treatment, or combinations thereof. At 1004, the aqueous suspension is heated to form a construct. In some embodiments, the aqueous suspension is heated after being poured into a mold of a desired size and shape. At 1006, the construct is dried under vacuum. At 1008, the dried construct is immersed in an aqueous liquid electrolyte to form a hydrogel electrolyte layer. At 1010, the hydrogel electrolyte layer is laminated with at least two electrode layers.

This process simplifies assembly of supercapacitors, and the electrolyte layer can be controlled precisely, e.g., by regulating concentration of electrolyte precursor. The electrolyte itself can operate from −50° C. to 90° C. and can be charge cycled up to 10,000 times. At $0.29 per gram, this is a cost-effective, durable supercapacitor that is operable at a wide range of temperatures.

Methods

Graphene was obtained from XFNANO Materials Tech Co., Ltd. DMF, H₂SO₄ and DMSO were purchased from Sinopharm Chemical Reagent Co., Ltd. MMT and PVA were obtained from Millipore Sigma company. PVDF were purchased from Aladdin Reagent company. Deionized water was home made.

Synthesis of MMT/PVA hydrogel electrolyte: Firstly, 90 mg PVA powder and 10 mg MMT material were added into 10 mL H₂O. Then, the suspension was dispersed evenly with ultrasonic equipment under ice bath for 1 h. After that, the solution was poured onto Teflon mold at temperature of 80° C. for 24 h. Then, the MMT/PVA construct was peeled off after vacuum drying for 24 h. Lastly, MMT/PVA hydrogel electrolyte was obtained after immersing into 2M H₂SO₄ DMSO/H₂O (mole ratio=1:1) solution for 24 h. Preparation of PVA contrast sample was followed the same processes without adding MMT material.

Fabrication of all-solid-state supercapacitors: Firstly, 50 mg graphene and 5 mg PVDF were dispersed in 10 mL DMF after 1 h of ultrasonic treatment under ice bath. Then, graphene dispersion was poured onto the mold and dried at 50° C. after 5 h to form graphene electrodes. Lastly, the supercapacitor was obtained by assembling two layers of graphene electrodes with one layer of hydrogel electrolyte.

Methods and systems of the present disclosure are advantageous to construct a cost-effective MMT/PVA hydrogel electrolyte with anti-freezing and thermally stable capability for all-temperature flexible supercapacitors. Incorporation of lamellar structural MMT materials not only improves the thermal stability of the hydrogel electrolyte but also promotes its ionic conductivity under electrochemical processes owing to the formation of conductive highways in the hydrogel electrolyte. The 2M H₂SO₄ DMSO/H₂O aqueous electrolyte with a freezing point below −50° C. provides sufficient ionic conductivities for electrochemical dynamics of supercapacitors. Moreover, the PVA substrate material simultaneously provides superior mechanical properties and a stable energy storage capacity of supercapacitors, demonstrated for over 1,000 cycles under flexible conditions, including bending, twisting, and stretching states. The supercapacitors deliver high specific capacitance of 161 F g⁻¹ at a current density of 1 A g⁻¹ with good rate performance at a high current density of 10 A g⁻¹. They also exhibit excellent air-working stability with a capacitance retention of 95% even after 10,000 cycles at 1 A g⁻¹. Furthermore, the high energy storage capacities remain even under a wide temperature range from −50 to 90° C., showing enormous potential for energy applications in harsh conditions.

It is noteworthy to mention that the price of the MMT/PVA hydrogel electrolyte is only about $0.29 g⁻¹, with promising capability for realizing mass production and commercialization in the market. These flexible supercapacitors can realize wide applications such as wearable and implantable devices, flexible electronics, sensors, batteries, fuel cells, thin-film energy storage devices, personalized healthcare and devices, smart cards, portable display technologies, printed electronics, space missions and technology, or other applications in extreme environments.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A flexible supercapacitor electrolyte, comprising:
a polymeric hydrogel matrix;
a concentration of montmorillonite material; and
an aqueous liquid electrolyte component incorporated into the polymeric hydrogel matrix.

2. The flexible supercapacitor electrolyte according to claim 1, wherein the montmorillonite material is substantially evenly dispersed in the polymeric hydrogel matrix.

3. The flexible supercapacitor electrolyte according to claim 1, wherein the polymeric hydrogel matrix includes poly(vinyl alcohol), polyacrylates, agarose, or combinations thereof.

4. The flexible supercapacitor electrolyte according to claim 1, wherein the mass ratio of montmorillonite material to polymeric hydrogel matrix (MMT:PHM) is between about 1:5 and about 1:15.

5. The flexible supercapacitor electrolyte according to claim 4, wherein the MMT:PHM is about 1:9.

6. The flexible supercapacitor electrolyte according to claim 1, wherein the aqueous liquid electrolyte has a melting temperature below about 0° C.

7. The flexible supercapacitor electrolyte according to claim 6, wherein the aqueous liquid electrolyte component includes sulfuric acid and dimethyl sulfoxide/water at a 1:1 molar ratio.

8. The flexible supercapacitor electrolyte according to claim 1, wherein the aqueous liquid electrolyte component has a concentration of about 2M.

9. A flexible supercapacitor comprising:
one or more pairs of electrode layers; and
a flexible supercapacitor electrolyte layer disposed between each pair of electrode layers, wherein the flexible supercapacitor electrolyte layer includes:
a polymeric hydrogel matrix;
a concentration of montmorillonite material; and
an aqueous liquid electrolyte component incorporated into the polymeric hydrogel matrix.

10. The flexible supercapacitor according to claim 9, wherein the montmorillonite material is substantially evenly dispersed in the polymeric hydrogel matrix.

11. The flexible supercapacitor according to claim 9, wherein the polymeric hydrogel matrix includes poly(vinyl alcohol), polyacrylates, agarose, or combinations thereof.

12. The flexible supercapacitor according to claim 9, wherein the mass ratio of montmorillonite material to polymeric hydrogel matrix (MMT:PHM) is about 1:9.

13. The flexible supercapacitor according to claim 9, wherein the aqueous liquid electrolyte component includes dimethyl sulfoxide (DMSO).

14. The flexible supercapacitor according to claim 13, wherein the aqueous liquid electrolyte component includes sulfuric acid and DMSO/water at a 1:1 molar ratio.

15. The flexible supercapacitor according to claim 9, wherein the aqueous liquid electrolyte component has a concentration of about 2M.

16. The flexible supercapacitor according to claim 9, wherein the electrode layers include graphene.

17. A method of making a flexible supercapacitor, comprising:
mixing an aqueous suspension including one or more polymers and a concentration of montmorillonite material;
heating the aqueous suspension to form a construct;
drying the construct under vacuum;
immersing the dried construct in an aqueous liquid electrolyte to form a hydrogel electrolyte layer; and
laminating the hydrogel electrolyte layer with at least two electrode layers.

18. The method according to claim 17, wherein the one or more polymers includes poly(vinyl alcohol) and the mass ratio of montmorillonite material to poly(vinyl alcohol) (MMT:PVA) is between about 1:9.

19. The method according to claim 17, wherein the aqueous liquid electrolyte is 2M sulfuric acid and dimethyl sulfoxide/water at a 1:1 molar ratio.

20. The method according to claim 17, wherein the electrode layers include graphene.
